(19) United States
(12) Patent Application Publication
(10) Pub. No.: US 2024/0235236 A1
(43) Pub. Date: Jul. 11, 2024

(54) Bidirectional Charging System and Control Method Thereof

(71) Applicants: Hyundai Motor Company, Seoul (KR); Kia Corporation, Seoul (KR)

(72) Inventors: Young Jin Jang, Seoul (KR); Sung Uk Park, Busan (KR); Chul Soon Kim, Guri-si (KR); Jae Hyun Kim, Incheon (KR); Dong Jun Lee, Suwon-si (KR); Won Yong Sung, Hwaseong-si (KR)

(21) Appl. No.: 18/347,749

(22) Filed: Jul. 6, 2023

(30) Foreign Application Priority Data
Jan. 11, 2023 (KR) 10-2023-0003958

(51) Int. Cl. H02J 7/00; B60L 1/00; B60L 55/00; H02J 7/04

(52) U.S. Cl. CPC H02J 7/00712; B60L 1/006; B60L 55/00; H02J 7/00711; H02J 7/04

(57) ABSTRACT

An embodiment method of controlling a bidirectional charging system includes operating a power supply mode to supply alternating current (AC) power to an external device connected to a vehicle, performing real-time current control to limit output current to a preset first current level or less during the power supply mode, determining that the real-time current control is not possible, in response to determining that the real-time current control is not possible, suspending the power supply mode temporarily, and resuming the power supply mode from a zero-crossing point of the AC power existing within a preset reference time from a time point at which the power supply mode is temporarily suspended.

### CROSS-REFERENCE TO RELATED APPLICATIONS

This application claims the benefit of Korean Patent Application No. 10-2023-0003958, filed on Jan. 11, 2023, which application is hereby incorporated herein by reference.

### TECHNICAL FIELD

The present disclosure relates to a bidirectional charging system and a control method thereof.

### BACKGROUND

Due to recent global trends in reducing carbon dioxide emissions, demand for electrified vehicles that generate driving power by driving motors with electrical energy stored in energy storage devices such as batteries, instead of typical internal combustion engine vehicles that generate driving power by combusting fossil fuels, is significantly increasing.

As an example of electrified vehicles, electric vehicles are equipped with a battery to store electrical energy to supply the motor to generate driving power, and a battery charging device (OBC: On Board Charger) to convert external power into power used for battery charging.

Recently, with the increase in battery capacity of electric vehicles, there has been a growing demand for the development of Vehicle to Load (V2L) technology to supply the vehicle's battery power to external devices connected to the vehicle's exterior using the battery charging device.

As an example of V2L technology, the battery charging device performs overcurrent diagnosis while supplying battery power to an external device. FIG. 1 is a graph showing alternating current (AC) and AC voltage output when an operation of outputting power from a conventional battery to an external device is performed. With reference to FIG. 1, a battery charging device may have a preset limit current for performing an overcurrent diagnosis. The limit current refers to the value set to prevent damage to the electronic components within the battery charging device due to overcurrent.

Therefore, the battery charging device stops outputting power of the battery to the external device when the AC output caused by an instantaneous overcurrent from the capacitive inrush current or a motor starting current of an electrical load reaches the limit current preset to prevent damage to electronic components in the device. The interruption of power output caused by an instantaneous overcurrent before the power supplied to the external device is stabilized may cause problems that render the operation of the external device impossible.

Subsequently, the battery charging device may be restarted by reducing the supply voltage to prevent the interruption of operation caused by the instantaneous overcurrent. However, if the voltage is reduced too much to meet the rated voltage of the external device, this may result in the device not functioning properly or becoming inoperable.

Although it may be considered to reduce the AC voltage input at the time of operation of the external device to solve the overcurrent problem that occurs during initial startup, the problem is that it is not possible to decrease the initial voltage supplied in line with the external device's ON state due to the nature of V2L technology which supplies battery power to the external device when the external device and the vehicle are connected and the external device's power is turned ON.

The foregoing is intended merely to aid in the understanding of the background of embodiments of the present disclosure and is not intended to mean that embodiments of the present disclosure fall within the purview of the related art that is already known to those skilled in the art.

### SUMMARY

The present disclosure relates to a bidirectional charging system and a control method thereof. Particular embodiments relate to a bidirectional charging system for providing the electric power of a battery of a vehicle to an external device connected to the vehicle and a control method thereof.

Embodiments of the present disclosure can solve problems in the art and provide a bidirectional charging system and a control method thereof for supplying battery power from a vehicle to a connected external device, while preventing interruption of power supply due to overcurrent and ensuring the continued operation of the external device even in the event of an overcurrent occurrence.

The technical features of embodiments of the present disclosure are not limited to the aforesaid, and other features not described herein with be clearly understood by those skilled in the art from the descriptions below.

A control method of a bidirectional charging system according to embodiments of the present disclosure may include operating a power supply mode for supplying AC power to an external device connected to a vehicle, performing real-time current control to limit output current to a preset first current level or less during the power supply mode, suspending the power supply mode temporarily in response to performing the real-time current control being impossible, and resuming the power supply mode from a zero-crossing point of the AC power existing within a preset reference time.

For example, performing the real-time current control may include reducing the output current by controlling a pulse-width modulation (PWM) signal of a plurality of switching elements to OFF in response to the output current exceeding the first current level during the power supply mode and performing the real-time current control by controlling the PWM signal of the plurality of switching elements to ON in response to the reduced output current reaching a second current level lower than the first current level.

For example, the first and second current levels may be lower than a third current level preset to determine whether to suspend the power supply mode during the power supply mode.

For example, performing the real-time current control may include determining whether real-time current control is performed based on at least one of a voltage value corresponding to the output current and the count of PWM controls of the plurality of switching elements in response to the reduced output current reaching the second current level.

For example, performing the real-time current control may include determining the voltage value corresponding to the output current in response to the reduced output current reaching the second current level and performing the real-time current control by controlling the PWM signal of the plurality of switching elements to ON in response to the determined voltage value exceeding a preset reference voltage.

For example, performing the real-time current control may include terminating the power supply mode by determining that the power supply mode is not operable normally due to external factors other than the operation of the external device in response to the determined voltage value being less than the preset reference voltage.

For example, performing the real-time current control may include accumulating the count of PWM controls of the plurality of switching elements, determining whether the accumulated count of controls exceeds a prestored reference count in response to the reduced output current reaching the second current level, and performing the real-time current control by controlling the PWM signal of the plurality of switching elements to ON in response to the accumulated count of controls being less than the reference count.

For example, performing the real-time current control may include terminating the real-time current control by determining that performing the real-time current control is not possible in response to the accumulated count of controls exceeding the reference count.

For example, resuming the power supply mode may include determining the voltage of the AC power from a time point when the power supply mode is temporarily suspended and resuming the power supply mode from the zero-crossing point without adjusting the voltage of the AC power in response to the determined zero-crossing point of the voltage of the AC power existing within the reference time.

For example, resuming the power supply mode may include resuming the power supply mode from the zero-crossing point by stepping down a voltage of the AC power in response to the determined zero-crossing point of the voltage of the AC power existing within the reference time.

For example, the reference time may be set in consideration of a hold-up time of a load operating based on the AC power.

Also, a bidirectional charging system according to embodiments of the present disclosure may include a battery and a bidirectional charger connected to the battery, wherein the bidirectional charger comprises a charging controller configured to perform real-time current control to limit an output current to a preset first current level or less in response to a power supply mode being activated, the power supply mode supplying AC power by converting power of the battery to an external device, suspending the power supply mode in response to performing the real-time current control not being possible, and resuming the power supply mode from a zero-crossing point of the AC power existing within a preset reference time.

For example, the bidirectional charger may further include a plurality of switching elements being ON or OFF based on a pulse-width modulation (PWM) signal, and the charging controller is further configured to reduce the output current by controlling pulse-width modulation (PWM) signal of a plurality of switching elements to OFF in response to the output current exceeding the first current level during the power supply mode and to perform the real-time current control by controlling the PWM signal of the plurality of switching elements to ON in response to the reduced output current reaching a second current level lower than the first current level.

For example, the charging controller may be further configured to determine whether real-time current control is performed based on at least one of a voltage value corresponding to the output current and the count of PWM controls of the plurality of switching elements in response to the reduced output current reaching the second current level.

For example, the charging controller may be further configured to determine the voltage value corresponding to the output current in response to the reduced output current reaching the second current level and to perform the real-time current control by controlling the PWM signal of the plurality of switching elements to ON in response to the determined voltage value exceeding a preset reference voltage.

For example, the charging controller may be further configured to terminate the power supply mode by determining that the power supply mode is not operable normally due to external factors other than operation of the external device in response to the determined voltage value being less than the preset reference voltage.

For example, the charging controller may be further configured to accumulate the count of PWM controls of the plurality of switching elements, determine whether the accumulated count of controls exceeds a prestored reference count in response to the reduced output current reaching the second current level, and perform the real-time current control by controlling the PWM signal of the plurality of switching elements to ON in response to the accumulated count of controls being less than the reference count.

For example, the charging controller may be further configured to terminate the real-time current control by determining that performing the real-time current control is not possible in response to the accumulated count of controls exceeding the reference count.

For example, the charging controller may be further configured to determine the voltage of the AC power from a time point when the power supply mode is temporarily suspended and to resume the power supply mode from the zero-crossing point without adjusting the voltage of the AC power in response to the determined zero-crossing point of the voltage of the AC power existing within the reference time.

For example, the charging controller may be further configured to resume the power supply mode from the zero-crossing point by stepping down a voltage of the AC power in response to the determined zero-crossing point of the voltage of the AC power existing within the reference time.

According to the bidirectional charging system and its control method of embodiments of the present disclosure, it is possible to prevent overcurrent and interruption of AC power supply due to overcurrent by controlling the output current in real-time when supplying AC power to the external device.

Additionally, by utilizing the zero-crossing point of voltage during the hold-up time after the occurrence of overcurrent to re-supply the AC power, the operation state of the external device can be maintained while preventing the occurrence of overcurrent during the initial operation of the external device.

The advantages of embodiments of the present disclosure are not limited to the aforesaid, and other advantages not described herein may be clearly understood by those skilled in the art from the descriptions below.

### BRIEF DESCRIPTION OF THE DRAWINGS

FIG. 1 is a graph showing AC current and AC voltage output when an operation of outputting power from a conventional battery to an external device is performed;

FIG. 2 is a block diagram illustrating a configuration of a bidirectional charging system according to an embodiment of the present disclosure;

FIGS. 3 and 4 are graphs for explaining a control of an AC current of a bi-directional charging system according to an embodiment of the present disclosure;

FIGS. 5 and 6 are graphs for explaining control of an AC voltage of a bidirectional charging system according to an embodiment of the present disclosure; and

FIG. 7 is a flowchart illustrating a control method of a bidirectional charging system according to an embodiment of the present disclosure.

### DETAILED DESCRIPTION OF ILLUSTRATIVE EMBODIMENTS

In addition, detailed descriptions of well-known technologies related to the embodiments disclosed in the present specification may be omitted to avoid obscuring the subject matter of the embodiments disclosed in the present specification. In addition, the accompanying drawings are only for ease of understanding of the embodiments disclosed in the present specification and do not limit the technical spirit disclosed herein, and it should be understood that the embodiments include all changes, equivalents, and substitutes within the spirit and scope of the disclosure.

As used herein, terms including an ordinal number such as “first” and “second” can be used to describe various components without limiting the components. The terms are used only for distinguishing one component from another component.

It will be understood that when a component is referred to as being “connected to” or “coupled to” another component, it can be directly connected or coupled to the other component or an intervening component may be present. In contrast, when a component is referred to as being “directly connected to” or “directly coupled to” another component, there are no intervening components present.

As used herein, the singular forms are intended to include the plural forms as well, unless the context clearly indicates otherwise.

It will be further understood that the terms “comprises” or “has,” when used in this specification, specify the presence of a stated feature, number, step, operation, component, element, or a combination thereof, but they do not preclude the presence or addition of one or more other features, numbers, steps, operations, components, elements, or combinations thereof.

Hereinafter, descriptions are made of the embodiments disclosed in the present specification with reference to the accompanying drawings in which the same reference numbers are assigned to refer to the same or like components and redundant description thereof is omitted.

In addition, the controller included in the name is only a term widely used for naming a controller that controls vehicle-specific functions and does not mean a generic function unit. For example, each controller may include a communication device communicating with another controller or sensor to control a function in charge, a memory that stores operating system or logic instructions and input/output information, and one or more processors for determination, operation, and decision-making necessary for functions in charge.

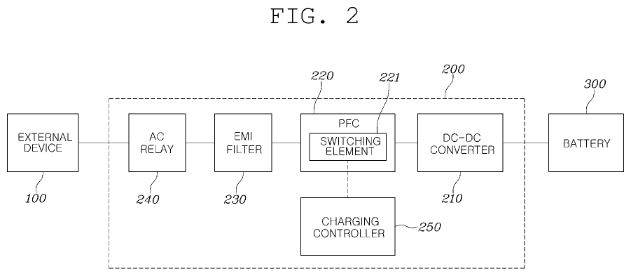

First, a description is made of the configuration of the bidirectional charging system according to an embodiment of the present disclosure with reference to FIG. 2.

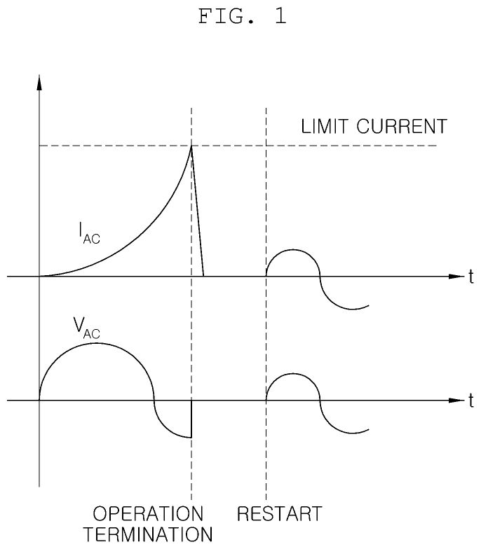

FIG. 2 is a block diagram illustrating a configuration of a bidirectional charging system according to an embodiment of the present disclosure. With reference to FIG. 2, the bidirectional charging system according to an embodiment of the present disclosure may include a bidirectional charger 200 and a battery 300. Also, the bidirectional charging system may be a component included in an electrified vehicle, and it is assumed that an external device 100 is connected to the electrified vehicle including the bidirectional charging system according to the embodiments of the present disclosure. FIG. 1 shows the components related to the embodiments of the present disclosure, and it is of course possible that the bidirectional charging system may include more or fewer components in actual implementation.

Hereinafter, each component will be described.

The external device 100 may refer to a device that operates by receiving AC power. For example, the external device 100 may be an electronic product including a laptop computer, an electric fan, a coffee machine, and the like, and when connected to an electrified vehicle, the external device 100 may operate by receiving AC power from the vehicle. A detailed description thereof will be made hereinafter.

The bidirectional charger 200 may be connected to the battery 300, and when AC power is input through an input terminal, the input AC power may be converted into direct current (DC) power, which is transmitted to the battery 300. In addition, the bidirectional charger 200 may output power stored in the battery 300 to the outside. That is, the bidirectional charger 200 may perform a charging mode for charging the battery 300 and a discharging mode for outputting power stored in the battery 300. The discharging mode may include a Vehicle to Grid (V2G) mode for supplying power from the battery 300 to the power system of the electrified vehicle and a Vehicle to Load (V2L) mode for supplying power from the battery 300 to an external device 100 connected to the electrified vehicle. For example, the bidirectional charger 200 may refer to a bidirectional on-board charger (OBC) integrated within an electrified vehicle.

The bidirectional charger 200 according to an embodiment of the present disclosure may include a DC-DC converter 210, a power factor controller (PFC) 220, an electromagnetic interference (EMI) filter 230, an AC relay 240, and a charging controller 250. However, this is only an example and the bidirectional charger 200 is not limited to the above configuration. For example, the bidirectional charger 200 may consist of only the DC-DC converter 210, the PFC 220, and the charging controller 250, and may necessarily include the DC-DC converter 210, the PFC 220, and the charging controller 250 along with the inclusion of at least one of the EMI filter 230 and the AC relay 240 depending on the case.

The DC-DC converter 210 may be connected to the battery 300 and regulate the DC power output from the battery 300 for supply to the PFC 220.

The PFC 220 is connected to the DC-DC converter 210 to convert DC power supplied from the DC-DC converter 210 into AC power based on a pulse-width modulation (PWM) signal and output the converted AC power. For example, when the external device 100 is connected to the bidirectional charger 200, the PFC 220 outputs AC current (I_{AC}) and AC voltage (V_{AC}) based on AC power to the external device 100. In addition, the PFC 220 may further include a plurality of switching elements 221 that are turned on or off based on a PWM signal.

The EMI filter 230 may remove electrical noise in order to supply normal AC power to the external device 100 connected to the bidirectional charger 200.

The AC relay 240 may control whether AC power is provided to the external device 100 connected to the bidirectional charger 200 by performing the ON/OFF of the relay.

Through this, the bidirectional charger 200 may supply power stored in the battery 300 to the external device 100 when the external device 100 is connected.

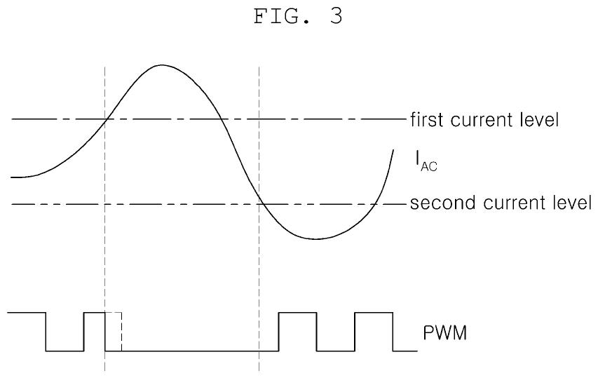

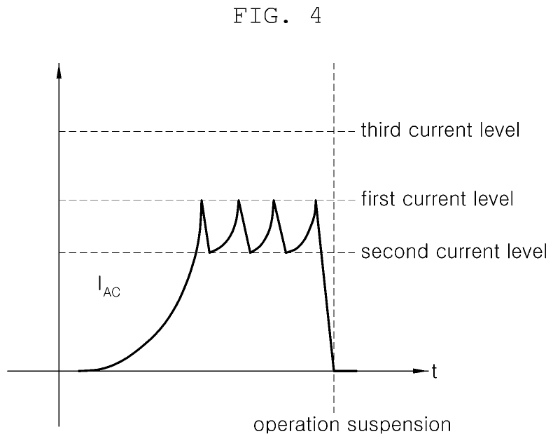

The charging controller 250 may control a relay or a switch included in the bidirectional charger 200 based on the operation mode of the bidirectional charger 200. In addition, the charging controller 250 may control the bidirectional charger 200 to prevent overcurrent from occurring based on the operation mode of the bidirectional charger 200 when the external device 100 is connected to the electrified vehicle. A detailed description thereof will be made later with reference to FIGS. 3 and 4.

Meanwhile, in the implementation of the charging controller 250, the charging controller 250 according to an embodiment of the present disclosure may be implemented as one function of an electronic control unit (ECU) included in the bidirectional charger 200. However, this is merely an example and not necessarily limited thereto. For example, the charging controller 250 may be implemented as a controller separate from the ECU, or its function may be distributed among two or more different controllers.

FIGS. 3 and 4 are graphs for explaining a control of an AC current of a bi-directional charging system according to an embodiment of the present disclosure.

When the external device 100 is connected, the bidirectional charger 200 may operate in the power supply mode for supplying AC power to the external device 100. When the bidirectional charger 200 operates in the power supply mode, the charging controller 250 may perform real-time current control to limit the output current to the external device 100 to a predetermined first current level or lower. For example, when the output current exceeds the first current level during the power supply mode operation, the charging controller 250 may turn off the PWM signals of the plurality of switching elements 221 to reduce the output current. Also, when the reduced output current reaches a second current level lower than the first current level, the charging controller 250 may turn on the PWM signals of the plurality of switching elements 221 to perform real-time current control.

First, with reference to FIG. 3, the output current (I_{AC}) output to the external device 100 may be in the form of an AC current. Accordingly, the first current level may be a value set in a section where the intensity of the output current increases, and the first current level may be a value set to determine the occurrence of overcurrent of the output current. When an overcurrent occurs, internal parts of the bidirectional charger 200 may be damaged or the power supply mode to the external device 100 may be interrupted. Accordingly, the charging controller 250 may control PWM signals of the plurality of switching elements 221 to maintain the power supply mode providing power to the external device 100 by ensuring that the intensity of the output current does not exceed the first current level. As the charging controller 250 controls the PWM signals of the plurality of switching elements 221 to be OFF, the plurality of switching elements 221 may be in an OPEN state, and thus the intensity of the output current may gradually decrease.

However, if the intensity of the output current is not monitored, the output current may enter a low current section and cause the operation of the external device 100 to fail. Therefore, the charging controller 250 may set a second current level, which is lower than the first current level, and when the decreased output current reaches the second current level, it may control the PWM signal of the plurality of switching elements 221 to be turned on again such that the output current is output. Here, the charging controller 250 may control the PWM signals of the multiple switching elements 221 to be turned on in consideration of the period of the PWM signals from the time when the PWM signals of the plurality of switching elements 221 are turned off. However, this is merely an example and not necessarily limited thereto.

Through the above-described process, the charging controller 250 may perform real-time control of the output current to prevent occurrence of overcurrent.

FIG. 4 is an example of an output current graph obtained by the charging controller 250 controlling the output current in real time. With reference to FIG. 4, when the external device 100 is connected and powered in the power supply mode, causing the output current to occur, the charging controller 250 may control the output current (I_{AC}) not to exceed the first current level and may control the reduced output current not to drop below the second current level. Meanwhile, a third current level may be set in the charging controller 250, and the third current level may refer to a current level that determines the termination of the power supply mode during the power supply mode operation. That is, when the output current reaches the third current level during the power supply mode operation, the power supply mode operation may be terminated and the power supply to the external device 100 may be discontinued.

However, according to embodiments of the present disclosure, the charging controller 250 may perform real-time output current control to prevent the occurrence of overcurrent in a state capable of supplying power to the external device 100 without terminating the power supply mode by controlling the output current based on the first and second current levels that are lower than the third current level.

Furthermore, when the reduced output current reaches the second current level, the charging controller 250 may determine whether to perform real-time current control based on at least one of the voltage values corresponding to the output current and the count of PWM controls of the plurality of switching elements 221. For example, when the reduced output current reaches the second current level, the charging controller 250 may determine a voltage value corresponding to the output current, and when the determined voltage exceeds a predetermined reference voltage, may control PWM signals of multiple switching elements 221 to ON to perform real-time current control.

The overcurrent may be caused by an inrush current or a driving current of the external device 100, but it may also be caused by combination or loss of other electronic components. Therefore, the charging controller 250 determines the voltage value corresponding to the output current when the reduced output current reaches the second current level, and based on the determined voltage value, it may determine whether the overcurrent is caused by the inrush current or the driving current of the external device 100 or by an external factor excluding the operation of the external device 100 (e.g., combination or loss). The voltage value based on the output current may be low when there is a combination or loss, and the charging controller 250 may set a reference voltage for use in determining whether there is a combination or loss. Accordingly, when the determined voltage value exceeds the predetermined reference voltage, the charging controller 250 may determine that an overcurrent has occurred due to the inrush current or the driving current of the external device 100 and perform real-time current control. However, when the determined voltage value is below the predetermined reference voltage, the charging controller 250 may determine that there is an external factor other than the operation of the external device 100, such as combination or loss, and may terminate the power supply mode by determining that the normal operation of the power supply mode is not possible.

Meanwhile, as shown in FIG. 4, if real-time current control is performed through the charging controller 250, the output current reaching the second current level may rise again to the first current level, and the control to reduce the output current reaching the first current level to the second current level may be performed. However, when this real-time output current control is continuously performed, it may be difficult to determine whether an overcurrent has occurred due to the inrush current or driving current of the external device 100 or due to an external factor other than the operation of the external device 100. Therefore, the charging controller 250 may perform real-time current control but may limit the number of times of current control.

For example, the charging controller 250 may accumulate the count of PWM controls of multiple switching elements 221 and, when the reduced output current reaches the second current level, it may determine whether the accumulated control count exceeds a prestored reference count. Here, the charging controller 250 may accumulate the count of PWM controls of multiple switching elements 221 by using at least one of the number of times the PWM signal of the multiple switching elements 221 is controlled to OFF, the number of times the PWM signal of the multiple switching elements 221 is controlled to ON, and the number of times the PWM signal of the multiple switching elements 221 is controlled from OFF to ON or from ON to OFF. Here, the prestored reference count may refer to the number of times that the charging controller 250 can correctly determine whether the overcurrent is caused by the inrush current or driving current of the external device 100 by performing real-time current control.

In embodiments of the present disclosure, the charging controller 250 may accumulate the number of times the PWM signal of multiple switching elements 221 is controlled to OFF to determine whether the real-time current control is performed. For example, as shown in FIG. 4, when the prestored reference count is 3 and the determined accumulated control count is less than the prestored reference count, the charging controller 250 may perform the real-time current control by controlling the PWM signals of the plurality of switching elements 221 to ON. However, if the determined accumulated control count exceeds the prestored reference count, i.e., 3, the charging controller 250 may determine that real-time current control cannot be performed and may terminate real-time current control. That is, the charging controller 250 may determine that the current control is no longer possible when the number of times that the PWM signals of the plurality of switching elements 221 are controlled to OFF reaches 4.

When overcurrent occurs even though real-time current control is performed, it is possible to prevent the occurrence of overcurrent by terminating the operation of the power supply mode and operating the external device 100 at the time when the AC power output from the bidirectional charger 200 is 0 or outputting the AC power after operating the external device 100. However, it may not be possible to set an operation time point of the external device 100, and it may also not be possible to operate the external device 100 in the absence of AC power. In addition, when the power supply mode is stopped and then restarted, the output current is cut off and then supplied to the external device 100 again, which may cause overcurrent to reoccur.

Accordingly, the charging controller 250 according to an embodiment of the present disclosure may temporarily suspend the power supply mode when it is not possible to perform real-time current control and resume the power supply mode from the zero-crossing point of AC power that occurs within a predetermined reference time. That is, when real-time current control cannot be performed, the charging controller 250 may suspend the power supply mode instead of terminating.

The external device 100 can maintain its operating state for a certain period of time even when the power supply mode is temporarily suspended, which may be referred to as the hold-up time. The hold-up time may be based on the load operating on AC power, and the hold-up time may vary depending on the load. For example, the hold-up time may be a time corresponding to 15 ms to 50 ms depending on the load, and if the hold-up time is 15 ms, this may mean that the load can maintain its operating state for 15 ms.

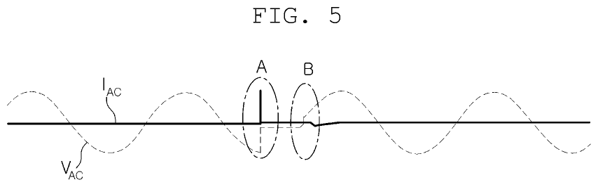

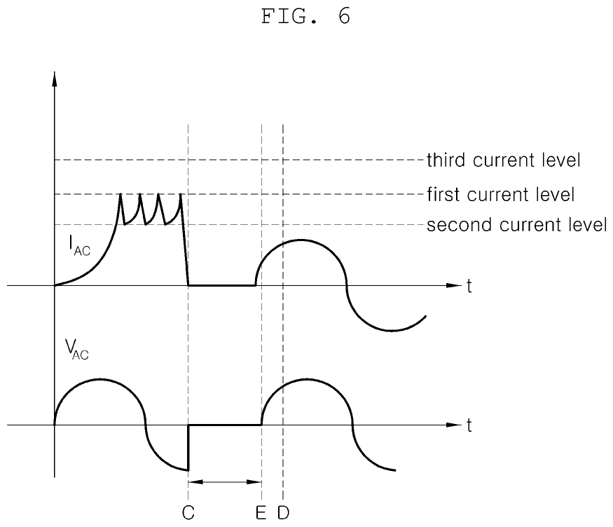

Therefore, the charging controller 250 can have a reference time set in consideration of the hold-up time of the external device 100. The reference time may be set shorter than the hold-up time, and the charging controller 250 may control the power supply mode to resume within the set reference time when the power supply mode is temporarily suspended in order for the external device 100 to operate continuously without interruption. A detailed description thereof is made with reference to FIGS. 5 and 6.

FIGS. 5 and 6 are graphs for explaining control of an AC voltage of a bidirectional charging system according to an embodiment of the present disclosure.

In detail, the charging controller 250 may determine the voltage of the AC power from the time when the power supply mode is temporarily suspended and may determine whether the zero-crossing point of the determined AC voltage exists within the reference time. And, if the determined zero-crossing point of the AC voltage exists within the reference time, the power supply mode may be resumed from the zero-crossing point.

With reference to FIG. 5, the waveform of the AC voltage (V_{AC}) due to the AC power may be shown, and the AC voltage may be determined within the reference time from the time point when the power supply mode is temporarily suspended, enabling resuming of the power supply mode. If the AC current (I_{AC}) suddenly spikes at a moment like point A and an overcurrent occurs, the charging controller 250 may temporarily suspend the power supply mode at point A. In addition, it is possible to determine whether there is a zero-crossing point of the AC voltage within the predetermined reference time from point A when the power supply mode is suspended. For example, when the AC voltage zero-crossing occurs at point B within the predetermined reference time from point A, the charging controller 250 may determine point B as the zero-crossing point of the AC voltage and resume the power supply mode from point B. When the power supply mode is resumed from the zero-crossing point of the AC voltage, the AC current may have a stable graph shape as shown in FIG. 5.

Therefore, the charging controller 250 may prevent the occurrence of overcurrent by finding the zero-crossing point of the AC voltage (V_{AC}) within the reference time from the time the power supply mode is suspended and, in response to detecting the zero-crossing point, resume the power supply mode from the zero-crossing point.

Descriptions are made of AC current and AC voltage according to the power supply mode operation with reference to FIG. 6.

With reference to FIG. 6, the charging controller 250 may perform real-time current control during the power supply mode operation, and when overcurrent occurs even with real-time current control, it can temporarily suspend the power supply mode. The charging controller 250 may determine whether there is a time point when the AC voltage zero-crossing occurs during the time interval between point C when the power supply mode is temporarily suspended and point D when the predetermined reference time ends. When there is point E at which the AC voltage zero-crossing occurs between points C and D, the charging controller 250 may control such that the power supply mode resumes at point E when the AC voltage zero-crossing occurs.

Also, the graph of FIG. 6 shows that when the power supply mode resumes from point E at which zero-crossing of AC voltage (V_{AC}) occurs, the AC voltage (I_{AC}) is normally supplied to the external device 100 without occurrence of overcurrent. And, by comparing the initial AC voltage at which the power supply mode operation started and the AC voltage at point E when the power supply mode resumed, it can be seen that the power supply mode has restarted with the same size as the initial AC voltage.

That is, the charging controller 250 may resume the power supply mode from the zero crossing point without adjusting the AC voltage when the zero crossing point of the AC voltage exists within a predetermined reference time from the time point when the power supply mode is suspended. However, this is merely an example and the embodiments are not necessarily limited thereto. For example, the charging controller 250 may step-down the AC voltage and resume the power supply mode from the zero-crossing point when the determined AC voltage zero-crossing point exists within the reference time.

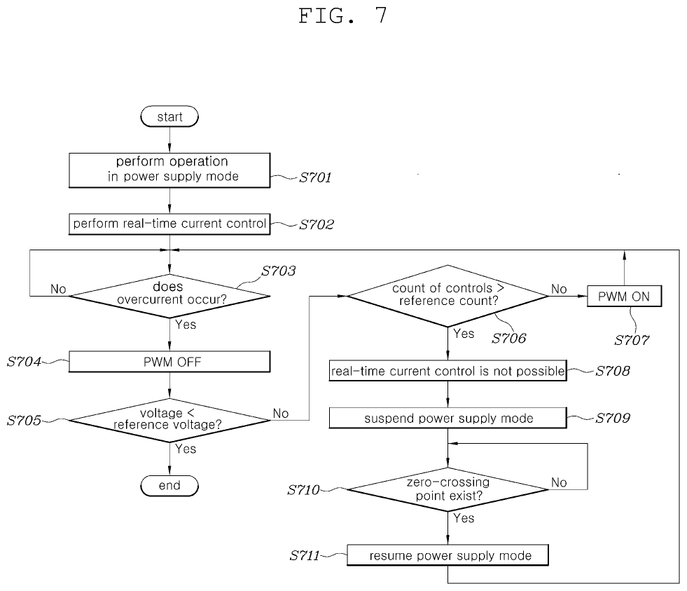

Hereinafter, a control method of the bidirectional charging system according to an embodiment will be described with reference to FIG. 7 based on the configuration of the bidirectional charging system described above with reference to FIG. 2.

FIG. 7 is a flowchart illustrating a control method of a bidirectional charging system according to an embodiment of the present disclosure.

With reference to FIG. 7, when the external device 100 is connected to a vehicle equipped with a bidirectional charging system, an operation is performed at step S701 in a power supply mode supplying AC power to the external device 100. When the operation in the power supply mode is performed, the charging controller 250 may perform, at step S702, real-time current control to limit the output current to a preset first current level or lower. The charging controller 250 may determine at step S703 whether an overcurrent occurs during real-time current control and, upon detection of an overcurrent exceeding the first current level (Yes at step S703), control the PWM signals of the multiple switching elements 221 to OFF at step S704.

In addition, the charging controller 250 may control the PWM signals of the plurality of switching elements 221 to OFF to reduce the intensity of the output current, and when the reduced output current reaches the second current level, a voltage value corresponding to the output current may be determined at step S705. For example, when the voltage value corresponding to the output current is less than the predetermined reference voltage (Yes at step S705), the charging controller 250 may terminate the power supply mode by determining that the power supply mode cannot be operated normally due to external factors such as fusion and damage.

When a voltage value corresponding to the output current is not less than a predetermined reference voltage (No at step S705), the charging controller 250 may determine at step S706 whether to perform the real-time current control based on the number of times the real-time current control is performed. When the number of real-time current controls is not greater than the prestored reference count (No at step S706), the charging controller 250 may determine that performing the real-time current control is possible and may perform the real-time current control by controlling the PWM signals of the plurality of switching elements 221 to ON at step S707.

However, when the number of real-time current controls exceeds the prestored reference count (Yes at step S706), the charging controller 250 may determine at step S708 that performing real-time current control is not possible and may terminate the real-time current control. Next, upon determining that real-time current control is not possible, simultaneously the charging controller 250 may temporarily suspend the power supply mode at step S709.

When the power supply mode is suspended, the charging controller 250 may determine the AC voltage caused by AC power and determine at step S710 whether there is a zero-crossing point of the AC voltage within the predetermined reference time from the time point when the power supply mode is temporarily suspended. When there is a zero-crossing point of the AC voltage within the predetermined reference time (Yes at step S710), the charging controller 250 may resume the power supply mode from the zero-crossing point at step S711.

As a result of the above-described configuration of embodiments of the present disclosure, it is possible to prevent the occurrence of overcurrent and the interruption of AC power supply due to overcurrent by controlling the output current in real time when supplying AC power to an external device.

Furthermore, by using the zero-crossing point of the voltage at the time of overcurrent occurrence to re-supply AC power, it is possible to prevent the occurrence of overcurrent at the initial start-up of the external device while maintaining the operating state of the external device.

Although specific embodiments of the disclosure are illustrated and described, it is obvious to those skilled in the art that this disclosure can be variously improved and changed without departing from the technical spirit of this disclosure that is provided by the claims appended hereinbelow.

Meanwhile, embodiments of the present disclosure described above may be implemented as computer-readable codes on a medium on which a program is recorded. Computer-readable media include all types of recording devices in which data readable by a computer system are stored. Examples of the computer-readable media include a hard disk drive (HDD), a solid state disk (SSD), a silicon disk drive (SDD), a ROM, a RAM, a CD-ROM, a magnetic tape, a floppy disk, an optical data storage device, etc. Accordingly, the above detailed description should not be construed as restrictive in all respects but as exemplary. The scope of the present disclosure should be determined by a reasonable interpretation of the appended claims and includes all modifications within the equivalent scope of the present disclosure.

What is claimed is:

1. A method of controlling a bidirectional charging system, the method comprising:
operating a power supply mode to supply alternating current (AC) power to an external device connected to a vehicle;
performing real-time current control to limit output current to a preset first current level or less during the power supply mode;
determining that the real-time current control is not possible;
in response to determining that the real-time current control is not possible, suspending the power supply mode temporarily; and
resuming the power supply mode from a zero-crossing point of the AC power existing within a preset reference time from a time point at which the power supply mode is temporarily suspended.

2. The method of claim 1, wherein performing the real-time current control comprises:
reducing the output current by controlling a pulse-width modulation (PWM) signal of a plurality of switching elements to OFF in response to the output current exceeding the first current level during the power supply mode; and
performing the real-time current control by controlling the PWM signal of the plurality of switching elements to ON in response to the reduced output current reaching a second current level lower than the first current level.

3. The method of claim 2, wherein the first current level and the second current level are lower than a third current level preset to determine whether to suspend the power supply mode during the power supply mode.

4. The method of claim 2, wherein performing the real-time current control comprises determining whether the real-time current control is performed based on a voltage value corresponding to the output current and a count of PWM controls of the plurality of switching elements in response to the reduced output current reaching the second current level.

5. The method of claim 4, wherein performing the real-time current control comprises:
determining the voltage value corresponding to the output current in response to the reduced output current reaching the second current level; and
performing the real-time current control by controlling the PWM signal of the plurality of switching elements to ON in response to the determined voltage value exceeding a preset reference voltage.

6. The method of claim 5, wherein performing the real-time current control comprises terminating the power supply mode by determining that the power supply mode is not operable normally due to external factors other than operation of the external device in response to the determined voltage value being less than the preset reference voltage.

7. The method of claim 4, wherein performing the real-time current control comprises:
accumulating the count of the PWM controls of the plurality of switching elements;
determining whether the accumulated count of the PWM controls exceeds a prestored reference count in response to the reduced output current reaching the second current level; and
performing the real-time current control by controlling the PWM signal of the plurality of switching elements to ON in response to the accumulated count of the PWM controls being less than the reference count.

8. The method of claim 7, wherein performing the real-time current control comprises terminating the real-time current control by determining that performing the real-time current control is not possible in response to the accumulated count of the PWM controls exceeding the reference count.

9. The method of claim 1, wherein resuming the power supply mode comprises:
determining a voltage of the AC power from the time point at which the power supply mode is temporarily suspended; and
resuming the power supply mode from the zero-crossing point without adjusting the voltage of the AC power in response to the determined zero-crossing point of the voltage of the AC power existing within the reference time.

10. The method of claim 9, wherein resuming the power supply mode comprises resuming the power supply mode from the zero-crossing point by stepping down the voltage of the AC power in response to the determined zero-crossing point of the voltage of the AC power existing within the reference time.

11. The method of claim 1, wherein the reference time is set in consideration of a hold-up time of a load operating based on the AC power.

12. A bidirectional charging system comprising:
a battery; and
a bidirectional charger connected to the battery, wherein the bidirectional charger comprises a charging controller configured to:
perform real-time current control to limit an output current to a preset first current level or less in response to a power supply mode being activated;
supply alternating current (AC) power to an external device by converting power of the battery during the power supply mode;
suspend the power supply mode in response to the real-time current control not being possible; and
resume the power supply mode from a zero-crossing point of the AC power existing within a preset reference time from a time point at which the power supply mode is suspended.

13. The bidirectional charging system of claim 12, wherein the bidirectional charger further comprises a plurality of switching elements in an ON or OFF state based on a pulse-width modulation (PWM) signal, and wherein the charging controller is further configured to:
reduce the output current by controlling the PWM signal of the plurality of switching elements to the OFF state in response to the output current exceeding the first current level during the power supply mode; and
perform the real-time current control by controlling the PWM signal of the plurality of switching elements to the ON state in response to the reduced output current reaching a second current level lower than the first current level.

14. The bidirectional charging system of claim 13, wherein the charging controller is further configured to determine whether the real-time current control is performed based on a voltage value corresponding to the output current and a count of PWM controls of the plurality of switching elements in response to the reduced output current reaching the second current level.

15. The bidirectional charging system of claim 14, wherein the charging controller is further configured to:
determine the voltage value corresponding to the output current in response to the reduced output current reaching the second current level; and
perform the real-time current control by controlling the PWM signal of the plurality of switching elements to the ON state in response to the determined voltage value exceeding a preset reference voltage.

16. The bidirectional charging system of claim 15, wherein the charging controller is further configured to terminate the power supply mode by determining that the power supply mode is not operable normally due to external factors other than operation of the external device in response to the determined voltage value being less than the preset reference voltage.

17. The bidirectional charging system of claim 14, wherein the charging controller is further configured to:
accumulate a count of PWM controls of the plurality of switching elements;
determine whether the accumulated count of the PWM controls exceeds a prestored reference count in response to the reduced output current reaching the second current level; and
perform the real-time current control by controlling the PWM signal of the plurality of switching elements to the ON state in response to the accumulated count of the PWM controls being less than the reference count.

18. The bidirectional charging system of claim 17, wherein the charging controller is further configured to terminate the real-time current control by determining that performing the real-time current control is not possible in response to the accumulated count of the PWM controls exceeding the reference count.

19. The bidirectional charging system of claim 12, wherein the charging controller is further configured to:
determine a voltage of the AC power from the time point when the power supply mode is suspended; and
resume the power supply mode from the zero-crossing point without adjusting the voltage of the AC power in response to the determined zero-crossing point of the voltage of the AC power existing within the reference time.

20. The bidirectional charging system of claim 19, wherein the charging controller is further configured to resume the power supply mode from the zero-crossing point by stepping down the voltage of the AC power in response to the determined zero-crossing point of the voltage of the AC power existing within the reference time.
